(19) United States
(12) Patent Application Publication
(10) Pub. No.: US 2020/0368982 A1
(43) Pub. Date: Nov. 26, 2020

(54) METHODS FOR MANUFACTURING CURVED FRAMES "3D ACETATE" FOR SPECTACLES

(71) Applicant: Thema Optical S.r.l., Domegge di Cadore (BL) (IT)

(72) Inventor: Roberto VALMASSOI, Domegge di Cadore (BL) (IT)

(21) Appl. No.: 16/768,363

(22) PCT Filed: Nov. 30, 2018
(86) PCT No.: PCT/IB2018/059515

§ 371 Date: May 29, 2020

(30) Foreign Application Priority Data
Dec. 1, 2017 (IT) 102017000139018

(51) Int. Cl. B29D 12/02; G02C 13/00

(52) U.S. Cl. CPC B29D 12/02; B29K 2001/12; G02C 13/001

(57) ABSTRACT

The invention relates to a method of fabricating acetate eyeglass frame fronts with a frame curvature and consequent lens seats, which is customized to conform with the curvature of the lenses to be fitted into said seats which, according to the visual defect to be corrected, may have different, possibly asymmetric, curvatures.

The invention also relates to the frames with curved fronts obtained with the method.

Fabrication is carried out by electronically controlled milling operations from an acetate plate (1), having predetermined thickness (S), length (L) and height (H) values, on which additional elements (2, 3, 4, 5) made of the same material, possibly of different colors, are applied, which are attached at least proximate to the end sides of the length extent (L) of the plate at the lens seats. Such additional elements help to locally increase the thickness (S) of the plate to a value (S1) that accommodates the dimensions that the frame shall have as a result of the curvature of the front at the lens seats, relative to the middle region, once the milling operations have been completed.

The additional elements (2, 3, 4, and 5) are pre-cut and then stably fixed to the plate (1) by direct friction welding on the plate, without using chemicals or adhesives.

The present invention relates to a method of fabricating eyeglass frames, namely from a material designed to be processed by milling, particularly but without limitation cellulose acetate, wood, metal or other materials.

As used herein, the term eyeglass frames is mainly intended to designate the front of the frame which, upon connection to the side temples and insertion of the lenses into their respective seats, constitutes the eyeglasses.

Eyeglass lenses, particularly those for correction of visual defects, are known to be typically curved, and their curvature, at the boundary that is designed to engage with the profile of the corresponding seat formed in the front, mainly depends on the nature of the lens, which in turn depends on the type of visual defect to be corrected for which the eyeglasses are designed.

The eyeglass frames made of the aforementioned materials, according to the prior art, are formed with processes that include a number of milling and cutting steps, starting from a plate of millable material having a length (L), a height (H) and a thickness (S).

The prior art e.g. EP 2,946,914, provides a plate having a length (L) and a height (H), defining a surface area including the perimeter boundary of the front of the eyeglass frame to be fabricated and having a thickness (S) whose value is at least equal to the maximum transverse dimensions of the three-dimensional configuration of the front and which evenly extends across the entire surface defined by the height H and the length L of the plate.

As described in EP 2,946,914, the fabrication process comprises the step of forming a groove into the surface dimensions of the plate along the perimeter boundary of the front to be fabricated, with at least one pair of material bridges being formed in the groove, spaced along the boundary, connecting said boundary to the plate, and the step of removing said section, thereby separating said front from the rest of the plate.

When fabricating fronts with a particular curvature, like fronts with special lens seats such as those designed for correcting visual defects, the transverse dimensions of the front due to the curvature are much greater than those generally ranging from 6 to 8 mm.

This means that, in the prior art, the thickness H of the starting plate that is used to form the front with seats for curved lenses must be much greater than the thickness sufficient to obtain a front whose thickness ranges from 6 to 8 mm.

This causes an increase of the costs for the starting material and the generation of much waste material, which entails pollution hazards and disposal issues.

Therefore, the object of the present invention is to provide a method of fabricating curved fronts for eyeglass frames, with customized lens seats that account for the curvature of the profile of the lens required for correcting a visual defect, starting from a plate having a height H, a thickness S and a length L, thereby reducing the scrap and the waste material and providing, if needed, fronts with parts having different colors.

These and other objects, as better explained hereafter, are fulfilled by a method of fabricating fronts of eyeglass frames, as characterized by claim 1 hereinafter.

The invention will be described in greater detail with reference to the annexed drawings, which are given by way of illustration and without limitation, in which:

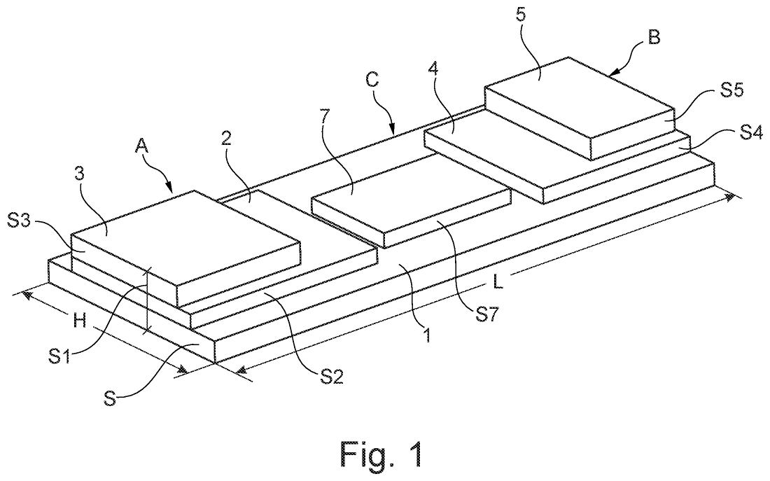

FIG. 1 shows a perspective view of the acetate plate from which the curved front of an eyeglass frame is formed according to the method of the invention;

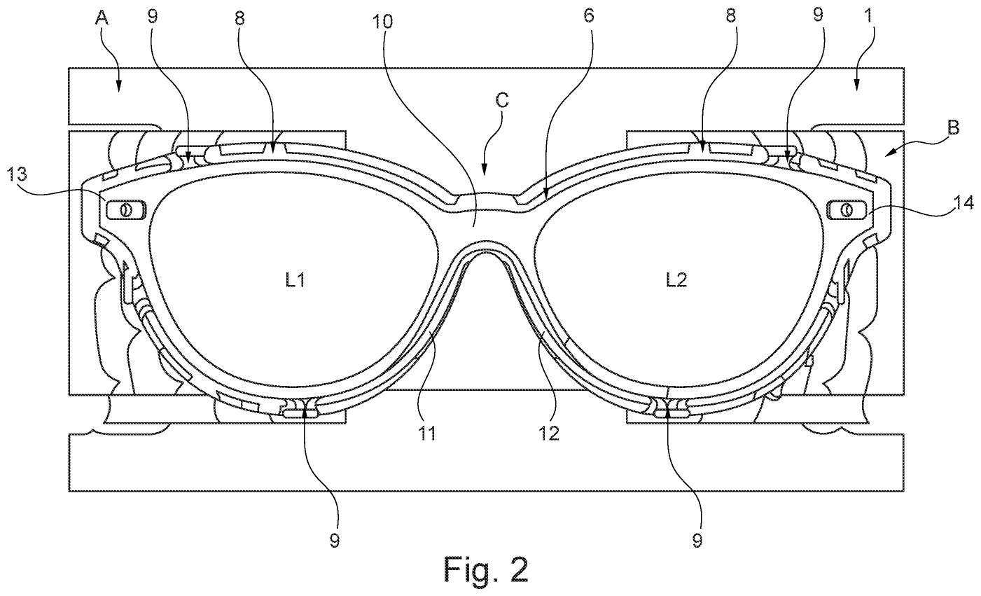

FIG. 2 shows a front view of the blank of a front of the frame during fabrication, when it is still connected to the base plate;

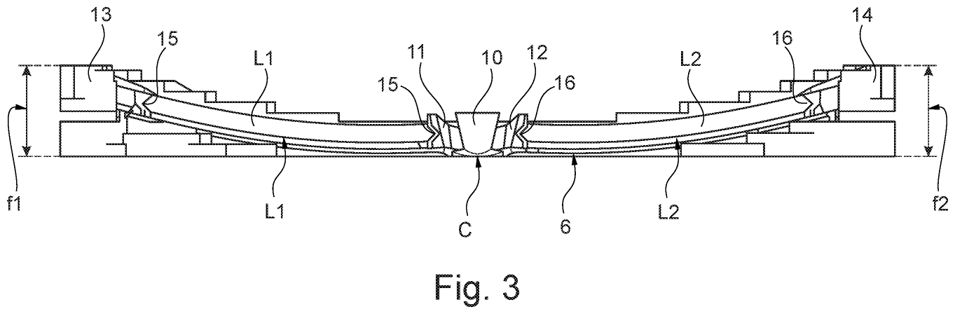

FIG. 3 shows a top view of the blank of FIG. 2; and

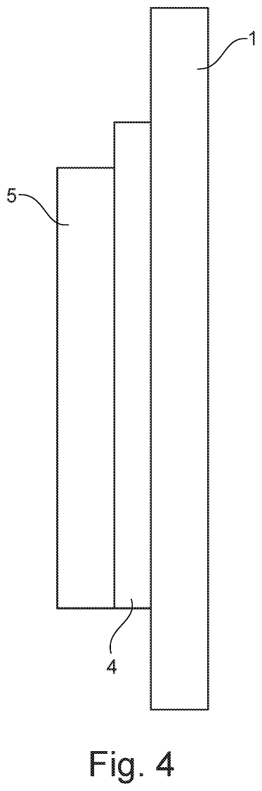

FIG. 4 shows a side view of the plate of FIG. 1.

Referring to the aforementioned figures, numeral 1 designates the acetate plate from which the front of the eyeglass frame has to be formed according to the method of the present invention. The plate has a rectangular shape, with a longitudinal dimension or length L, a transverse dimension or height H and a thickness S.

Such length L and height H dimensions, according to the invention, define a surface area that encompasses the perimeter boundary of the body of the frame front to be formed, e.g. the front part with the lens seats.

Preferably, the aforementioned area of the acetate plate 1 is larger than that defined by the boundary of the front to be fabricated, even though to a limited extent to avoid unnecessary material waste.

According to the present invention, the thickness S of the plate, proximate to the end sides A and B of the length L, with the front having lens seats, is increased to a given total value S1, through the application of additional elements 2, 3, 4, 5, made of the same material as the base plate 1, possibly having different colors.

The application of these additional elements 2, 3, 4, 5, to the plate 1 is effected by a so-called “friction welding” operation, whereby precut elements are directly welded to the plate, without using chemicals or glues.

This is obtained by heating the surfaces to be joined due to the friction caused by a relative movement on the welding plane and followed by the application of pressure.

Alternatively, the aforementioned additional elements are added by direct injection of plastic material on the plate.

Each of said additional elements has its own thickness s2, s3, s4, s5, which is added to the thickness S of the plate 1, to increase the thickness of the relevant regions to a value S1.

Said thickness value S1 is such as to include, at the end of the milling operations, the values of the deflections f1 and f2 that the front, referenced 6 in FIGS. 2 and 3, shall assume in association with the curvature of the front at the lens seats L1 and L2 relative to the middle region C of the front, once milling of said lens seats is completed, depending on their actual curvature. e.g. in response to the prescription for visual defect correction.

According to the invention, an additional element 7 having a thickness s7, may also be applied in the middle region C of the plate 1, to thereby increase thickness in this region to account for a possible desired front curvature in the region of the frame front that rests on the nose.

In order to carry out the method of the invention, the plate 1 is attached to a support of a non-conventional, specially designed CNC milling machine, having a first axis about which it may be subjected to angular movements imparted by a servomotor.

Referring to the manufacture of a frame front, as shown in FIGS. 2, 3 and 4, the method of the invention comprises forming a cut 8 in the plate 1, along the perimeter boundary of the front, and removing the material at the lens seats L1 and L2.

The cut 8 is not formed continuously, but leaves some portions of the boundary connected to the plate 1 by material bridges 9.

Then, a suitable tool is used to form, in the thickness S1 of the regions A and B of the plate, the three-dimensional body of the front with the lens seats L1 and L2 having the required curvature, a nose bridge 10 already having its typical curved configuration, bridge arms 11 and 12 for the frame to rest upon the nose, as well as the endpieces 13 and 14 for connection to the temples, the latter not being shown.

The process of the invention also comprises the step of forming lens receiving grooves 15 and 16 in the seats L1 and L2 along their respective boundaries.

Once the blank of the front has been prepared, the material bridges 9 are removed and the blank is separated from the plate 1.

Conventional finishing steps are now carried out.

It will be appreciated from the above disclosure that the steps of the inventive method are carried out using a numerical-control apparatus, by imparting the necessary movements to the tool head 16, and the support 3 with the plate 1 secured thereto.

The various movements are imparted and controlled by a conventional computer program that can be designed for each front template to be created and with a proper curvature at the lens seats L1, L2 depending on the type thereof, which will avoid any unnecessary material waste.

The dimensions may be changed as needed, without departure from the scope of the invention as disclosed above and claimed below.

1. A method of fabricating eyeglass frame fronts, the method comprising:
providing a plate made of millable material, adapted to form an eyeglass frame, having a length, a height, and a thickness; and
increasing the thickness of the plate, at least at end regions of the length of the plate where lens seats are formed, to a value which is adapted to accommodate transverse dimensions of the front resulting from required curvature of the lens seats;
wherein the increasing of the thickness of the plate comprises applying prefabricated additional elements in overlapping relationship to the end regions,
wherein the additional elements are fixed to each other and to the plate and rigidly joined thereto,
wherein each additional element has a predetermined thickness, and
wherein the additional elements are applied by friction welding of precut elements.

2. The method of claim 1, wherein the friction welding of the additional elements is carried out directly on the plate.

3. The method of claim 1, wherein the friction welding of the additional elements is carried out without using chemicals or adhesives.

4. The method of claim 1, further comprising:
increasing the thickness of the plate also at a region of the frame front that rests on a nose of a wearer of the eyeglass frame.

5. The method of claim 1, wherein the increasing of the thickness of the plate, at least at the end regions of the length, comprises applying prefabricated additional elements in overlapping relationship to the end regions,
wherein the additional elements are fixed to each other and to the plate and rigidly joined thereto, and
wherein each additional element has a predetermined thickness.

6. The method of claim 1, wherein the increasing of the thickness of the plate comprises molding additional plastic layers directly on the end regions of the length of the plate to a thickness which is adapted to accommodate the transverse dimensions of the front resulting from the required curvature of the lens seats.

7. The method of claim 1, wherein the material of the additional elements is a same material that is used to make the plate.

8. The method of claim 1, wherein the material of the additional elements has a different color than the plate.

9. An eyeglass frame whose front is obtained using the method of claim 1.
